(19) United States
(12) Patent Application Publication
(10) Pub. No.: US 2017/0237998 A1
(43) Pub. Date: Aug. 17, 2017

(54) METHOD AND APPARATUS FOR GENERATING A VIDEO FIELD/FRAME

(71) Applicant: InSync Technology Limited, Petersfield (GB)

(72) Inventor: James Edward SHEPHERD, Havant (GB)

(73) Assignee: InSync Technology Limited

(21) Appl. No.: 15/258,048

(22) Filed: Sep. 7, 2016

(30) Foreign Application Priority Data
Feb. 17, 2016 (GB) 1602790.6

(51) Int. Cl. H04N 19/31; H04L 12/26

(52) U.S. Cl. CPC H04N 19/31; H04L 43/16; H04N 19/172

(57) ABSTRACT

Aspects of the present invention relate to a method and apparatus for generating a video field Rₖ within a video field sequence R of N_{R} video fields. The method comprises determining a temporal alignment parameter C_{Rk} indicative of a temporal alignment of a start time T_{Ck} of a conversion time interval Cₖ within a sequence C of N_{R} conversion time intervals with respect to a source video frame Sᵢ within a source video frame sequence S, wherein the sequence C of conversion time intervals comprises a duration equal to a duration P_{S} of the source video frame sequence S. A source video frame from the source video frame sequence S from which to generate the video field Rₖ is then determined based at least partly on the temporal alignment parameter, and the video field Rₖ generated from the determined source video frame.

### FIELD OF THE INVENTION

This invention relates to a method and apparatus for generating a video field or frame, and in particular to a method and apparatus for generating a video field Rₖ within a video field sequence R of N_{R} video fields.

### BACKGROUND OF THE INVENTION

Television broadcast schedules are required to be optimised to generate the highest possible revenue, which is achieved through selling high value advertising spots. In many countries, legislation exists which mandates a minimum of actual programming hours per elapsed hour, which allows a certain amount of advertising per hour.

In order to maximise usage of the allowed advertising slots, broadcasters want programming material which does not exceed the minimum legal requirement, and as many advertisements as possible to fill the allowed advertising slots. Accordingly, if a programme delivered to a broadcaster is longer than required for optimal scheduling, it is desirable to reduce the running time of the content. Similarly, if the programme is too short for the legally required duration, it is desirable to increase the running time of the programme. Such modifications can be made to advertisements also.

In the early days of television broadcasting, such programme duration increases or decreases were made by manual editing, e.g. removing segments of a programme or repeating segments. More recently, automated techniques have been developed that allow the running time of video material to be increased or reduced. Such known automated techniques involve the dropping or repeating of frames or fields, and/or interpolation (linear or motion compensated) of frames or fields.

The problem with the dropping or repeating of frames or fields is that programme material is essentially discarded in the case of frame dropping, and that visually disturbing freezes can be created in the case of frame repeating. Furthermore, there can be audible audio disturbances if relevant audio information is dropped or repeated when the video frame is processed. Significantly, where a large programme length change is needed, there would not be, in general, enough scene cuts for such methods to achieve the required duration modification.

Interpolation methods involve a continuous interpolation process, effectively creating an output video sequence at a nominally higher or lower frame rate than the input. When this is replayed at the original frame rate, the sequence will be of longer playback duration (in the case of a higher nominal output frame rate) or of shorter playback duration (in the case of a lower nominal output frame rate). The main disadvantage of such methods is that, unless the frame interpolation method is very sophisticated (e.g. using motion compensated interpolation), the output video may suffer visible quality defects such as blurring in areas of motion.

More complex methods apply a hybrid of the frame drop/repeat method combined with some form of interpolation when there are insufficient scene cuts or static areas. Such methods risk the introduction of artefacts from both blurring/frame blending due to the interpolation, and loss of relevant picture material due to frame dropping.

Accordingly, there is a need for an improved technique for enabling the running time of video material to be adjusted (reduced or increased) that overcomes at least some of the above identified problems with conventional techniques.

### SUMMARY OF THE INVENTION

According to a first aspect of the present invention there is provided a method of generating a video field Rₖ within the output video field sequence R, the output video sequence R consisting of N_{R} fields, where 0≦k<N_{R}. The method comprises determining a temporal alignment parameter C_{Rk} indicative of a temporal alignment of a start time T_{Ck} of a conversion time interval Cₖ within a sequence C of N_{R} conversion time intervals with respect to a source video frame Sᵢ within the source video frame sequence S, wherein the sequence C of conversion time intervals Cᵢ comprises a duration equal to a duration P_{S} of the source video frame sequence S. A source video frame from the source video frame sequence S from which to generate the video field Rₖ is then determined based on the temporal alignment parameter C_{Rk}, and the video field Rₖ is then generated from the determined source video frame.

In this manner, video fields Rₖ for the output video field sequence R are able to be dynamically generated such that the resulting output video sequence R comprises a predetermined and adaptable duration P_{R}.

According to some further embodiments, the method may comprise comparing the temporal alignment parameter C_{Rk} to a threshold value Z, and determining the source video frame from which to generate the video field Rₖ based on the comparison of the temporal alignment parameter C_{Rk} to the threshold value Z.

According to some further embodiments, the method may comprise selecting one of the source video frame Sᵢ and the source video frame Sᵢ₊₁ as the source video frame from which to generate the video field Rₖ based on the comparison of the temporal alignment parameter C_{Rk} to the threshold value Z.

According to some further embodiments, the temporal alignment parameter C_{Rk} may comprise a fractional component of the start time T_{Ck} in source frame units.

According to some further embodiments, the method may further comprise determining whether the field Rₖ comprises a field 1 or a field 2, and generating the video field Rₖ further based on the determination of whether the field Rₖ comprises a field 1 or field 2 where field 1 and field 2 are defined below.

According to some further embodiments, the method may comprise:
generating the video field Rₖ from the determined source video frame using a field 1 sample grid for a first field Rₖ; and
generating the video field Rₖ from the determined source video frame using a field 2 sample grid for a second field Rₖ.

According to some further embodiments, the method may further comprise outputting the generated video field Rₖ.

According to some further embodiments, the method may comprise outputting the generated video field Rₖ as part of a video stream comprising the video field sequence R of N_{R} video fields.

According to some further embodiments, the method may comprise outputting the generated video field Rₖ to at least one of:
a video transmission apparatus;
a display apparatus; and
a data storage device.

According to a second aspect of the present invention there is provided a video processing apparatus comprising at least one video field generator component for performing the method of the first aspect of the invention.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified diagram showing an example of a conversion of a source video frame sequence to an output video field sequence.

FIG. 2 illustrates a simple diagram representing a conventional 2:3 pull-down process for the 24 Hz to 60 Hz conversion.

FIG. 3 illustrates a simplified flowchart of an example of the method of generating video fields within the output video field sequence of FIG. 1.

FIG. 4 illustrates an example of the conversion of the source video frame sequence to the output video field sequence.

FIG. 5 illustrates a simplified flowchart of an alternative example of the method of generating video fields within the output video field sequence of FIG. 1.

FIG. 6 illustrates a simplified block diagram of an example of a video processing system.

### DETAILED DESCRIPTION OF THE PREFERRED EMBODIMENTS

The present invention will now be described with reference to the accompanying drawings. However, it will be appreciated that the present invention is not limited to the specific examples herein described and as illustrated in the accompanying drawings. For example, examples of the present invention are herein described primarily with reference to the reduction of the program length of a source video sequence by means of adjusting the generation of output video fields. However, it will be appreciated that the present invention provides a method for generating video fields that enables both the reduction and increase in the resulting output program relative to the source content. In addition, and as will become apparent below, the use of the term ‘field’ as used herein is intended to encompass, without limitation, an individual field within video sequences consisting of segmented frames such as interlaced/progressive segmented video sequences, and an individual frame within non-segmented frame video sequences.

Furthermore, because the illustrated embodiments of the present invention may for the most part, be implemented using electronic components and circuits known to those skilled in the art, details will not be explained in any greater extent than that considered necessary as illustrated below, for the understanding and appreciation of the underlying concepts of the present invention and in order not to obfuscate or distract from the teachings of the present invention.

It is understood that in the context of interlaced video sequences, two fields, field 1 and field 2, make up one interlaced video frame, and field 1 always precedes field 2 within the interlaced video sequence. Field 1 typically may comprise the odd numbered lines of the frame or the even numbered lines of the frame, depending on the originating video standard. Similarly, field 2 typically may comprise the even numbered lines of the frame or the odd numbered lines of the frame, depending on the originating video standard. As an example, in Phase Alternating Line (PAL) television systems, field 1 comprises the odd numbered active frame lines in each interlaced video frame and field 2 comprises even numbered active frame lines, whereas in National Television System Committee (NTSC) systems, field 1 comprises even numbered active frame lines from each interlaced video frame and field 2 comprises odd numbered active frame lines.

Furthermore, references are made herein to video rates of 24 Hz and 60 Hz. Common content acquisition rates are 24/1.001 Hz and 60/1.001 Hz (sometimes referred to in the broadcast industry as 23.98 and 59.94 Hz). It is to be understood that the use of the term “24 Hz” as used herein is intended to encompass both 24 Hz and 24/1.001 Hz video rates unless expressly stated otherwise, and the use of the term 60 Hz as used herein is intended to encompass both 60 Hz and 60/1.001 Hz video rates unless expressly stated otherwise.

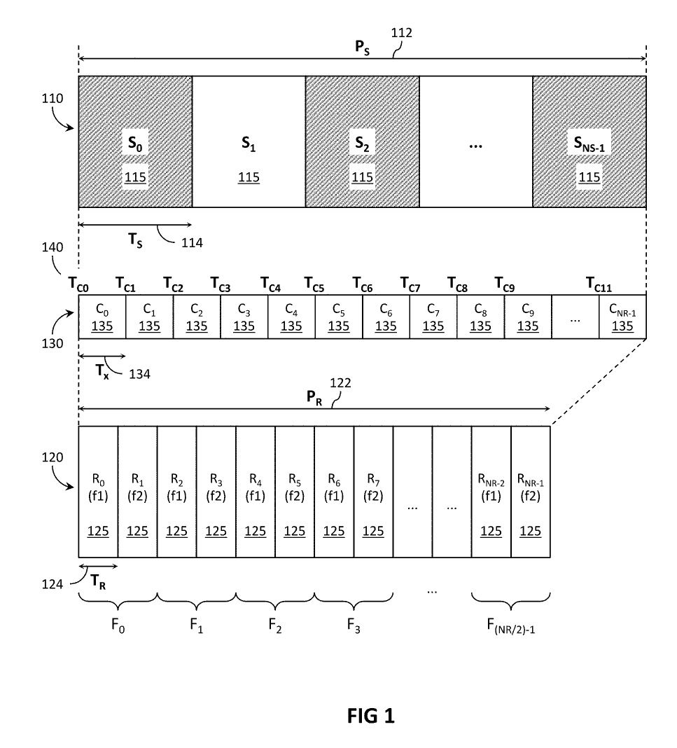

Referring first to FIG. 1, there is illustrated a simplified diagram showing an example of a conversion of a source video frame sequence S 110 to an output video field sequence R 120. For example, programme content for television distribution is commonly captured at a nominal rate of 24 Hz as progressive frames. This capture and post-production format is then later converted to 60 Hz interlace for transmission. Thus, in the example illustrated in FIG. 1, the source video frame sequence S 110 may consist of a capture and post production format having a nominal frame rate of 24 Hz, which is required to be converted to the output video field sequence R 120 consisting of a 60 Hz interlace format.

The process by which 24 Hz material is commonly converted to 60 Hz is informally termed “telecine” or 2:3 pull-down, referring to the original transfer of 24 Hz film content to 60 Hz interlaced video for television transmission. As is well known in the field, creating an output 60 Hz interlaced sequence of the same running length as the 24 Hz source material requires deriving ten output fields 125 for every four source frames 115.

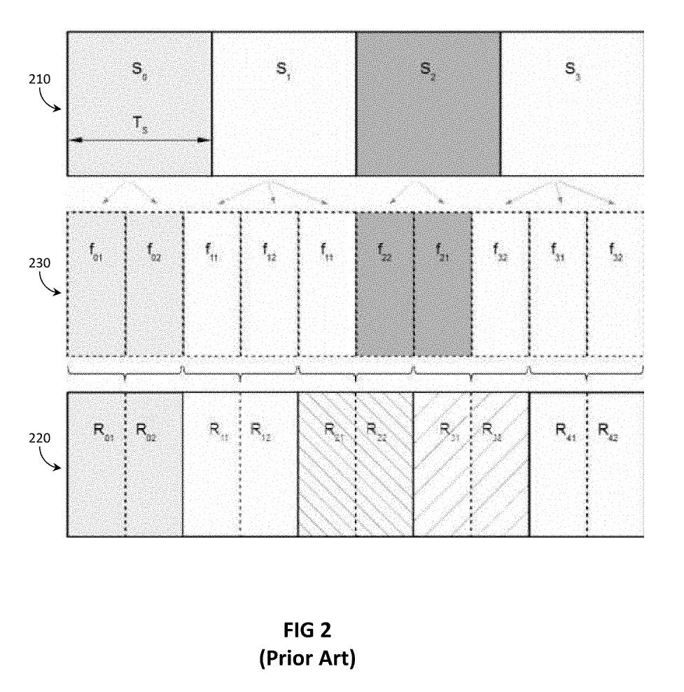

A simple diagram representing a conventional 2:3 pull-down process for the 24 Hz to 60 Hz conversion is shown in FIG. 2. In a conventional 2:3 pull-down process, the source frames Sᵢ within the source video frame sequence S 210 are used to generate a series of intermediate interlaced fields fᵢ 230, where 2 or 3 interlaced fields are generated from each source frame Sᵢ in a consistent, alternating 2:3 pattern.

For example, source frame S₀ is used to generate two intermediate interlaced fields (f₀₁ and f₀₂), whereby source frame S₀ is optically scanned or digitally sampled with appropriate filtering using a field 1 sample grid to generate the intermediate field f₀₁. The same source frame S₀ is then sampled again using a field 2 sample grid to generate the intermediate field f₀₂.

The second source frame S₁ is used to generate three intermediate interlaced fields (f₁₁, f₁₂ and f₁₁), whereby image content of the second source frame S₁ is sampled using the field 1 sample grid, generating intermediate field f₁₁. The second source frame S₁ is then sampled again using the field 2 sample grid, generating intermediate field f₁₂. In the case of the second source frame S₁, image content of the second source frame S₁ is again sampled using the field 1 sample grid, generating a further intermediate field f₁₁.

The output frame sequence 220 is then created using the intermediate fields 230.

Irrespective of how many fields are generated from a given source frame Sᵢ, the sampled intermediate fields fᵢ must always alternate between afield 1 and afield 2 as per normal interlaced video. Interlaced video is recorded and broadcast as a whole number of interleaved frames comprising a field 1 and a subsequent field 2. For example, as illustrated in FIG. 2, output fields R₁₁ and R₁₂ comprise one 30 Hz output frame.

As outlined above, there is a need for enabling the running time of video material to be adjusted (reduced or increased). In accordance with some example embodiments of the present invention, and referring back to FIG. 1 there is provided a method of generating a video field Rₖ 125 within the output video field sequence R 120, the output video sequence R consisting of N_{R} fields 125. As described in greater detail below, the method comprises determining a temporal alignment parameter C_{Rk} indicative of a temporal alignment of a start time T_{Ck} of a conversion time interval Cₖ 135 within a sequence C 130 of N_{R} conversion time intervals with respect to a source video frame Sᵢ 115 within the source video frame sequence S 110, wherein the sequence C 130 of conversion time intervals Cᵢ 135 comprises a duration equal to a duration P_{S} 112 of the source video frame sequence S 110. A source video frame 115 from the source video frame sequence S 110 from which to generate the video field Rₖ 125 is then determined based on the temporal alignment parameter C_{Rk}, and the video field Rₖ 125 is then generated from the determined source video frame.

In this manner, and as described in greater detail below, video fields Rₖ 125 for the output video field sequence R 120 are able to be dynamically generated such that the resulting output video sequence R 120 comprises a predetermined and adaptable duration P_{R} 122.

The method of adapting the running length of the output video field sequence R 120 is achieved by adapting the ratio of the number of output fields N_{R} to the number of source frames N_{S}. For example, taking the source video sequence S 110 of duration P_{S} 112, consisting of N_{S} frames, which are timed at 24 frames per second, i.e. having a frame period T_{S} 114 of 1/24 seconds, it is desired to produce output video field sequence R 120 having a duration P_{R} 122.

Given that the output video field sequence R 120 must comprise a whole number N_{R} of fields Rₖ 125, the duration P_{R} 122 is necessarily an integer number N_{R} of fields, each with a predefined duration T_{R} 124. Accordingly:

P_{R}=T_{R}*N_{R} Equation 1

Furthermore, in the case of the output video field sequence R 120 comprising an interlace format, the output video field sequence R 120 must necessarily be a whole number of frames, with each frame consisting of consecutive fields 1 and 2. Thus, the desired choice of output duration P_{R} 122 may only be such that N_{R} is even. In any event, the desired choice of output duration P_{R} 122 defines the number N_{R} of fields Rₖ 125 in the output video field sequence R 120.

As shown in FIG. 1, a notional sequence C 130 of N_{R} conversion time intervals Cᵢ 135 is derived having a duration equal to the duration P_{S} 112 of the source video sequence S 110, with each conversion time intervals Cᵢ 135 having a period T_{X} 134, where:

Tₓ=Pₛ/N_{R} Equation 2

Accordingly, and as described in greater detail below, the sequence C 130 of N_{R} conversion time intervals Cᵢ 135 may be used to determine from which source frame 115 each output video field Rₖ 125 is to be generated.

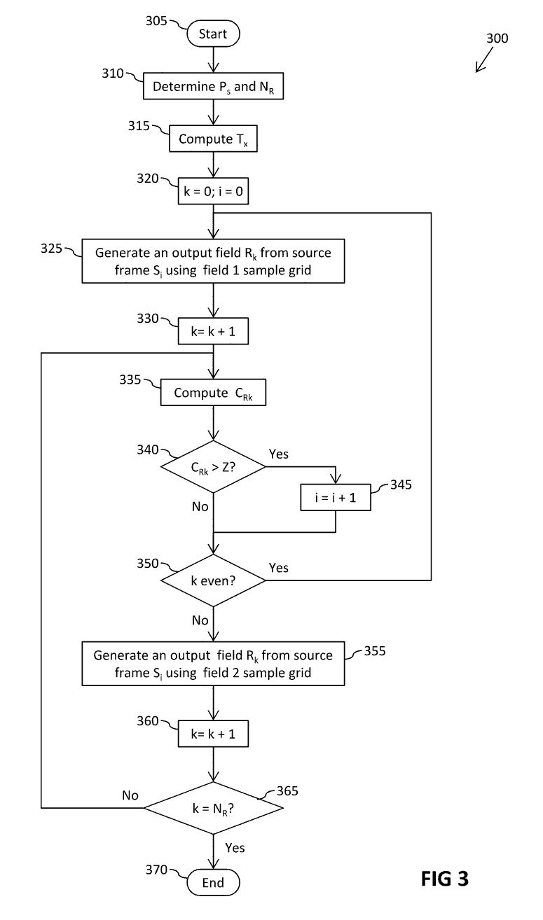

FIG. 3 illustrates a simplified flowchart 300 of an example of the method of generating video fields Rₖ 125 within the output video field sequence R 120 of FIG. 1. In the example illustrated in FIG. 3, the method comprises generating video fields Rₖ 125 within an interlaced output video field sequence R 120.

The method starts at 305, and moves on to 310 where the duration P_{S} 112 of the source video sequence S 110 and the number N_{R} of fields Rₖ 125 in the output video field sequence R 120 are determined. Such determinations may be by way of user input, or through being derived from the source video sequence S 110 itself (in the case of the duration P_{S} 112) and a required duration P_{R} 122 for the output video field sequence R 120 (in the case of the N_{R} of fields Rₖ 125). The period T_{X} 134 for the conversion time intervals Cᵢ 135 is then computed, at 315, and counter values k and i are initialised at 320.

A first field (Rₖ=R₀) 125 is then generated from the first source frame (Sᵢ=S₀) 115 using a field 1 sample grid, and outputted at 325. Since the field Rₖ 125 generated at 325 is a first field within the interlaced output video field sequence R 120, at least one further field must be generated in order to complete the field 1/field 2 interlaced field pairing. Accordingly, the method moves on to 330, where the counter k is incremented.

A temporal alignment parameter C_{Rk} indicative of a temporal alignment of a start time T_{Ck} of the conversion time interval Cₖ 135 within the sequence C 130 of conversion time intervals with respect to the source video frame Sᵢ is then computed, at 335. For example, and referring back to FIG. 1, the start time T_{Ck} 140 of each conversion time interval Cₖ 135 may be found by:

T_{Ck}=k*Tₓ Equation 3

The start time T_{Ck} of a conversion time interval Cₖ 135 may further be expressed in terms of source frame units S_{Ck}:

S_{Ck}=T_{Ck}/T_{S} Equation 4

A fractional component F_{Ck} of this source frame unit value S_{Ck} may then be obtained, which represents the temporal alignment of the start time T_{Ck} 140 of the conversion time interval Cₖ 135 with respect to its immediately preceding source frame Sᵢ:

F_{Ck}=S_{Ck} modulo 1 Equation 5

Substituting Equations 3 and 4 into Equation 5 gives:

F_{Ck}=(k*Tₓ/T_{S}) modulo 1 Equation 6

The index i of the immediately preceding source frame Sᵢ:

i=floor(k*Tₓ/T_{S}) Equation 7

That is to say, i is equal to the largest integer not greater than the source frame unit value S_{Ck}, and thus is equal to the largest integer not greater than (k*Tₓ/T_{S}). Accordingly, the fractional component F_{Ck} may be obtained by the alternative expression:

F_{Ck}=(k*Tₓ/T_{S})−i Equation 8

The fractional component F_{Ck} may then be used as (or to otherwise used to derive) the temporal alignment parameter C_{Rk} indicative of the temporal alignment of the start time T_{Ck} of the conversion time interval Cₖ 135.

Accordingly, referring back to FIG. 3, the temporal alignment parameter C_{Rk} is computed at 335, for example as:

C_{Rk}=(k*Tₓ/T_{S})−i Equation 9

Hence, in this first instance for step 335, when k=1 and i=0, a temporal alignment parameter C_{R1} for the start time T_{C1} (FIG. 1) of the second conversion time interval C₁ 135 with respect to the first source video frame S₀ is computed as: 1*(Tₓ/Tₛ)−0=(Tₓ/Tₛ).

Having computed the temporal alignment parameter C_{Rk}, the method moves on to 340 where, in the illustrated example, it is compared to a threshold value Z to determine the source video frame 115 from which to generate the video field Rₖ 125. In particular for the example illustrated in FIG. 3, the temporal alignment parameter C_{Rk} is compared to the threshold value Z to determine whether the video field Rₖ 125 is to be generated from the ‘current’ source frame Sᵢ (e.g. if the temporal alignment parameter C_{Rk} is less than the threshold Z) or from the ‘next’ source frame Sᵢ₊₁ (e.g. if the temporal alignment parameter C_{Rk} is greater than the threshold Z). Accordingly, in the method illustrated in FIG. 3, if the temporal alignment parameter C_{Rk} is greater than the threshold Z, the counter i is incremented, at 345, so that the ‘next’ source frame Sᵢ₊₁ becomes the new ‘current’ source frame Sᵢ and the method proceeds to 350. Conversely, if the temporal alignment parameter C_{Rk} is less than the threshold Z, the method proceeds directly to 350.

The choice of threshold Z determines the timing of a transition from one source frame 115 to the next, from which the output video fields 125 are generated. In effect, adjusting the threshold Z creates a variable sub-field latency, on average, in the delivery of image samples. Hence, the threshold Z has implications for the alignment of the image component of a programme following conversion with respect to other programme content such as audio.

Ultimately, the relative timing of the image component with respect to the audio component is a subjective choice but where image samples are uneven or deviate from the presentation of audio samples, it is widely recognised that images presented early with respect to audio are significantly more preferable to images presented late with respect to audio for the simple reason that the former never occurs in normal real-world experience whereas, due to the finite and relative speeds of light and sound, the latter occurs frequently in real-world experience.

For the case of normal 2:3 pull-down as illustrated in FIG. 2, image content is presented alternately co-timed with audio content then one half output field period early. Normal 2:3 pull-down conversion may be obtained using the method illustrated in FIG. 3 by a value of N_{R} equal to N_{S}*2.5 and a threshold Z in the range 0.4<Z<0.8. In this case, the 2:3 output field pattern will always start on a two field derivation from the first source frame S₀.

In general, to ensure that the audio always lags behind the video, we must ensure that the increment, i, for the source frame 115 from which an output field Rₖ 125 is generated meets the criterion that the start time of the chosen source frame Sᵢ used to generate the output field Rₖ 125 may only be up to a maximum of one output field period T_{R} 124 early.

For a normal 2:3 pattern, one output field period is 40% of the duration of a source frame period. Therefore Z=1−(40/100)=0.6 would provide the optimum output for a normal 2:3 pattern. When the programme length P_{R} 122 (FIG. 1) of the output video field sequence R 120 is to be modified, although the threshold value Z does not affect the programme length P_{R} 122 of the output video field sequence R 120, various factors should be taken into consideration. It is not necessary to create a consistently repeating 2:3 pattern as in a conventional “telecine” conversion of 24 Hz progressive to 60 Hz interlaced video. Instead a sequence of output fields 125 may be generated where 2 or 3 output fields 125 are generated from each source frame 115, in a sequence which may not necessarily have a specific repeating pattern.

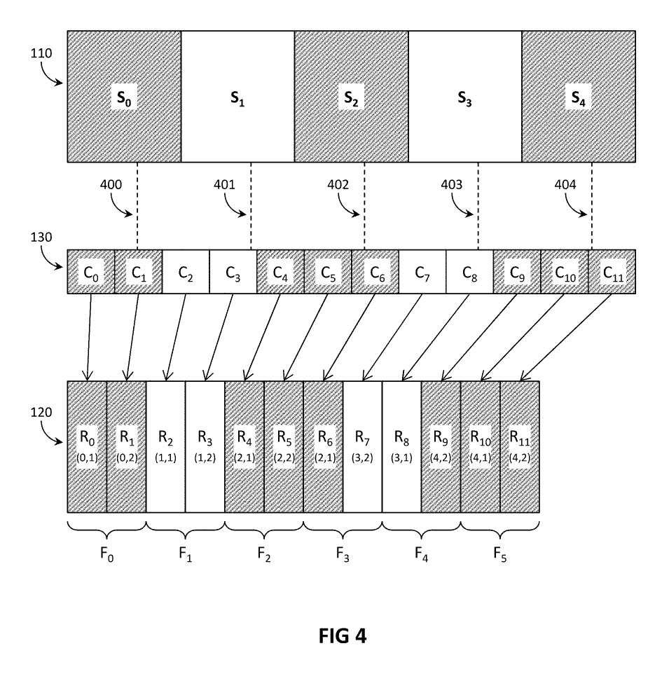

FIG. 4 illustrates an example of the conversion of the source video frame sequence S 110 to the output video field sequence R 120. In FIG. 4, the effect of the threshold value Z for each source frame Sᵢ 115 is illustrated by a dashed line 400-404. The temporal alignment of the start times T_{Ck} 140 (FIG. 1) of the conversion time interval Cₖ 135 determines from which source frames 115 the respective output fields 125 are generated. For the example illustrated in FIG. 4, the output fields 125 that are generated have a source frame pattern that starts 2:2:3:2:3. As previously mentioned, in the case of an interlaced output field sequence R 120, the output fields Rₖ must always alternate between a field 1 and a field 2, irrespective of from which source frame 115 each output field 125 is generated, with each field 1/field 2 interlaced field pairing within the output video field sequence 120 forming an output frame F₀-F₅. Notably, for the example illustrated in FIG. 4, the two output frames F₃ and F₄ each consists of video fields 125 generated from different source frames 115.

It is preferable that the difference in time between the presentation of any source frame 115 versus the presentation of the same image content in an output field 125 should never be greater than one output field period T_{R} 124 (FIG. 1), in order to minimise visible quality defects. In addition, it is preferable that there be consistent location of the discontinuities to enable any related audio processing to correctly track the video frame presentation times, thereby enabling correct lip-sync etc. Any audio-video discrepancies after programme re-timing should be such that the audio is delayed with respect to the video, which is subjectively less obvious to a viewer than audio which is advanced with respect to video.

The optimum choice of threshold Z can be calculated from the desired programme length duration reduction.

Let us define a duration change scaling, d, such that:

P_{R}=d*P_{S} Equation 10

where 0<d<1. As noted above, to ensure that the difference in time between the presentation of any source frame 115 versus the presentation of the same image content in an output field 125 should never be greater than one output field period T_{R} 124, we must ensure that the start time of the chosen source frame Sᵢ used to generate the output field Rₖ 125 may only be up to a maximum of one output field period T_{R} 124 early. In the case where one output field period T_{R} 124 is 40% of the duration of a source frame period T_{S} 114 (for example where T_{S}= 1/24 s and T_{R}=60 s), and for a decrease or increase in programme length of d, the optimum threshold value Z may be determined as:

Z=1−(0.4/d) Equation 11

For example, for a 4% programme duration decrease, d=0.96, giving a threshold value of: Z=1−0.4/0.96=0.583. Conversely, for a 4% programme duration increase, d=1.04, giving a threshold value of: Z=1−0.4/1.04=0.615.

Referring back to FIG. 3, at 350 in the illustrated example it is determined whether the counter value k is an even number; i.e. whether the video field Rₖ to be generated is a field 1 of the respective interlace video frame (as indicated by an even counter value k) or a field 2 of the respective interlace video frame (as indicated by an odd counter value k). In this first instance for step 350, the counter value k has a value of 1, i.e. an odd value. Accordingly, the method moves on to 355 where a second field (R₁) 125 is then generated from the source frame (Sᵢ) 115, which in this first instance for step 350 is the first source frame (S₀) using a field 2 sample grid, and outputted.

Since the field Rₖ 125 generated at 355 is a field 2 within the interlaced output video field sequence R 120, the method moves on to 360 where the counter k is incremented. It is then determined whether the output field Rₖ 125 generated at step 355 was the last field in the sequence R 120; i.e. whether the counter value k=(N_{R}−1), at 365. If it is determined that the output field Rₖ 125 generated at step 355 was the last field in the sequence R 120, the method ends at 370. However, if it is determined that the output field Rₖ 125 generated at step 355 was not the last field in the sequence R 120, the method loops back to step 335.

Referring back to step 350, if it is determined that the counter value k is an even number, the method loops back to 325 where the next field (Rₖ) 125 is generated from the first source frame (S₀) 115 using the field 1 sample grid.

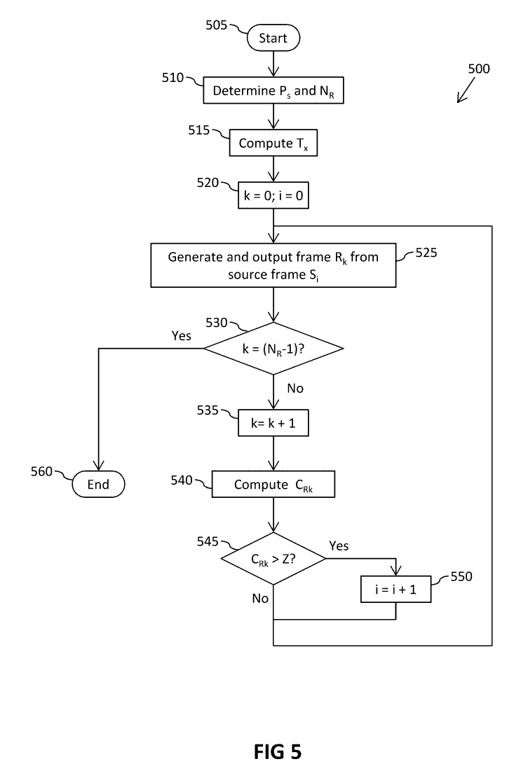

Referring now to FIG. 5, there is illustrated a simplified flowchart 500 of an alternative example of the method of generating video fields Rₖ 125 within the output video field sequence R 120 of FIG. 1. In the example illustrated in FIG. 5, the method comprises generating video fields Rₖ 125 within a non-interlaced output video field sequence R 120. In the case of such a non-interlaced video field sequence R 120, each individual video field Rₖ 125 makes up a video frame. Accordingly the use of the term ‘field’ in relation to such a non-interlace video field sequence is intended to be interpreted as being interchangeable with the term ‘frame’ in such a context.

The method starts at 505, and moves on to 510 where the duration P_{S} 112 of the source video sequence S 110 and the number N_{R} of fields Rₖ 125 in the output video field sequence R 120 are determined. Such determinations may be by way of user input, or through being derived from the source video sequence S 110 itself (in the case of the duration P_{S} 112) and a required duration P_{R} 122 for the output video field sequence R 120 (in the case of the N_{R} of fields Rₖ 125). The period T_{X} 134 for the conversion time intervals Cᵢ 135 is then computed, at 515, and counter values k and i are initialised at 520.

A first field (Rₖ=R₀) 125 is then generated from the first source frame (Sᵢ=S₀) 115, and outputted at 525. The method then moves on to 530 where it is then determined whether the output field Rₖ 125 generated at step 525 was the last field in the sequence R 120; i.e. whether the counter value k=(N_{R}−1). If it is determined that the output field Rₖ 125 generated at step 525 was the last field in the sequence R 120, the method ends at 560. However, if it is determined that the output field Rₖ 125 generated at step 525 was not the last field in the sequence R 120, the method moves on to 535 where the counter k is incremented.

A temporal alignment parameter C_{Rk} indicative of a temporal alignment of a start time T_{Ck} of the conversion time interval Cₖ 135 within the sequence C 130 of conversion time intervals with respect to the source video frame Sᵢ is then computed at 540, for example as described above in relation to the method of FIG. 3.

Having computed the temporal alignment parameter C_{Rk}, the method moves on to 545 where, in the illustrated example, it is compared to a threshold value Z to determine the source video frame 115 from which to generate the video field Rₖ 125. In particular for the example illustrated in FIG. 5, the temporal alignment parameter C_{Rk} is compared to the threshold value Z to determine whether the video field Rₖ 125 is to be generated from the ‘current’ source frame Sᵢ (e.g. if the temporal alignment parameter C_{Rk} is less than the threshold Z) or from the ‘next’ source frame Sᵢ₊₁ (e.g. if the temporal alignment parameter C_{Rk} is greater than the threshold Z). Accordingly, in the method illustrated in FIG. 5, if the temporal alignment parameter C_{Rk} is greater than the threshold Z, the counter i is increment, at 550, so that the ‘next’ source frame Sᵢ₊₁ becomes the new ‘current’ source frame Sᵢ and the method loops back to 525. Conversely, if the temporal alignment parameter C_{Rk} is less than the threshold Z, the method loops directly back to 525.

Although the above description refers specifically to programme duration reduction or expansion in the case of a 24 Hz progressive to 60 Hz interlaced conversion, it is equally applicable to any other frame rate conversion. In particular, content which is sourced at 60 Hz interlaced with a 2:3 cadence initially applied may in a first step be reverted to its original 24 Hz frame pattern using a method known to broadcast engineers as “reverse telecine”.

It should be noted that the amount of programme length reduction or expansion enabled by the method disclosed above will be affected by the amount of consecutive 3 field or 2 field frames which the end viewer will find subjectively acceptable. Thus it may be noted that the method allows a maximum of 20% reduction in programme length (where d=0.8) and a maximum of 20% increase in programme length where (d=1.2).

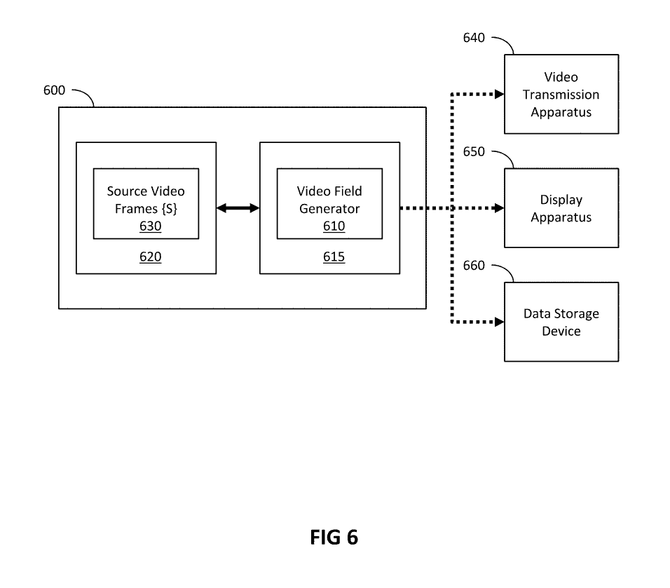

Referring now to FIG. 6, there is illustrated a simplified block diagram of an example of a video processing system 600. The video processing system 600 comprises a video field generator component 610 arranged to generate a video field Rₖ within an output video field sequence R, the output video sequence R consisting of N_{R} fields. In particular, the video field generator component 610 is arranged to determine a temporal alignment parameter C_{Rk} indicative of a temporal alignment of a start time T_{Ck} of a conversion time interval Cₖ within a sequence C of N_{R} conversion time intervals with respect to a source video frame Sᵢ within the source video frame sequence S, wherein the sequence C of conversion time intervals Cᵢ comprises a duration equal to a duration P_{S} of the source video frame sequence S. Having determined the temporal alignment parameter C_{Rk}, the video field generator component 610 is arranged to determine a source video frame from the source video frame sequence S from which to generate the video field Rₖ based on the temporal alignment parameter C_{Rk}, and to generate the video field Rₖ from the determined source video frame.

In the example illustrated in FIG. 6, the video field generator component 610 is implemented by way of computer program code executed on one or more processor devices, such as the processor device 615. As such, the video processing system 600 further comprises at least one memory element 620 comprising a tangible and non-transitory computer program product within which the executable program code forming the video field generator component 610 may be stored and loaded from for execution.

The memory element 620 may comprise, for example and without limitation, one or more of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; Magnetoresistive random-access memory (MRAM); volatile storage media including registers, buffers or caches, main memory, RAM, etc.

In the example illustrated in FIG. 6, source video frames 630 from which output video fields Rₖ are generated are also stored and accessed from the memory element 620.

In accordance with some example embodiments of the present invention, the video field generator component 610 may be arranged to perform one of the methods of generating a video field Rₖ as illustrated in FIG. 3 or FIG. 5. In the illustrated example, the video field generator component 610 is further arranged to output generated video fields Rₖ. For example, the video generator component 610 may be arranged to output generated video fields Rₖ to one or more of a video transmission apparatus 640, a display apparatus 650 and an external data storage device 660. Additionally/alternatively, the video generator component 610 may be arranged to output generated video fields Rₖ to the memory element 620.

The video field generator 610 has been illustrated and described as being implemented by way of computer program code executed on one or more processor devices. However, it is contemplated that the video field generator 610 is not limited to being implemented by way of computer program code, and it is contemplated that any suitable alternative implementation may equally be employed. For example, it is contemplated that one or more steps of the methods illustrated in FIGS. 3 and 5 may, at least in part, be implemented within hardware, for example within an application specific integrated circuit (ASIC) device or the like.

As previously identified, the invention may be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a tangible and non-transitory computer readable storage medium or transmitted to the computer system via a computer readable transmission medium. All or some of the computer program may be provided on computer readable media permanently, removably or remotely coupled to an information processing system. The tangible and non-transitory computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the scope of the invention as set forth in the appended claims and that the claims are not limited to the specific examples described above.

Those skilled in the art will recognize that boundaries between the above described operations are merely illustrative. For example, multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, the examples, or portions thereof, may be implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps than those listed in a claim. Furthermore, the terms ‘a’ or ‘an,’ as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an.’ The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

We claim:

1. A method of generating a video field Rₖ within a video field sequence R of N_{R} video fields, where 0≦k<N_{R}; the method comprising:
determining a temporal alignment parameter C_{Rk} indicative of a temporal alignment of a start time T_{Ck} of a conversion time interval Cₖ within a sequence C of N_{R} conversion time intervals with respect to a source video frame Sᵢ within a source video frame sequence S, wherein the sequence C of conversion time intervals comprises a duration equal to a duration P_{S} of the source video frame sequence S;
determining a source video frame from the source video frame sequence S from which to generate the video field Rₖ based at least partly on the temporal alignment parameter; and
generating the video field Rₖ from the determined source video frame.

2. The method of claim 1, wherein the method comprises comparing the temporal alignment parameter C_{Rk} to a threshold value Z, and determining the source video frame from which to generate the video field Rₖ based on the comparison of the temporal alignment parameter C_{Rk} to the threshold value Z.

3. The method of claim 2, wherein the method comprises selecting one of the source video frame Sᵢ and the source video frame Sᵢ₊₁ as the source video frame from which to generate the video field Rₖ based on the comparison of the temporal alignment parameter C_{Rk} to the threshold value Z.

4. The method of claim 1, wherein the temporal alignment parameter C_{Rk} comprises a fractional component of the start time T_{Ck} in source frame units.

5. The method of claim 1, wherein the method further comprises determining whether the field Rₖ comprises a field 1 or a field 2, and generating the video field Rₖ further based on the determination of whether the field Rₖ comprises a field 1 or a field 2.

6. The method of claim 5, wherein the method comprises:
generating the video field Rₖ from the determined source video frame using a field 1 sample grid if the field Rₖ comprises a field 1; and
generating the video field Rₖ from the determined source video frame using a field 2 sample grid if the field Rₖ comprises a field 2.

7. The method of claim 1, wherein the method further comprises outputting the generated video field Rₖ.

8. The method of claim 7, wherein the method comprises outputting the generated video field Rₖ as part of a video stream comprising the video field sequence R of N_{R} video fields.

9. The method of claim 7, wherein the method comprises outputting the generated video field Rₖ to at least one of:
a video transmission apparatus;
a display apparatus; and
a data storage device.

10. A video processing apparatus comprising at least one memory element within which a source video frame sequence S is stored and at least one video field generator component for generating a video field Rₖ within a video field sequence R of N_{R} video fields, where 0≦k<N_{R}; wherein the at least one video field generator component is arranged to:
determine a temporal alignment parameter C_{Rk} indicative of a temporal alignment of a start time T_{Ck} of a conversion time interval Cₖ within a sequence C of N_{R} conversion time intervals with respect to a source video frame Sᵢ within the source video frame sequence S, wherein the sequence C of conversion time intervals comprises a duration equal to a duration P_{S} of the source video frame sequence S;
determine a source video frame from the source video frame sequence S from which to generate the video field Rₖ based at least partly on the temporal alignment parameter; and
generate the video field Rₖ based on the determined source video frame.

11. The video processing apparatus of claim 10, wherein the video field generator component is arranged to compare the temporal alignment parameter C_{Rk} to a threshold value Z, and determine the source video frame from which to generate the video field Rₖ based on the comparison of the temporal alignment parameter C_{Rk} to the threshold value Z.

12. The video processing apparatus of claim 11, wherein the video field generator component is arranged to select one of the source video frame Sᵢ and the source video frame Sᵢ₊₁ as the source video frame from which to generate the video field Rₖ based on the comparison of the temporal alignment parameter C_{Rk} to the threshold value Z.

13. The video processing apparatus of claim 10, wherein the temporal alignment parameter C_{Rk} comprises a fractional component of the start time T_{Ck} in source frame units.

14. The video processing apparatus of claim 10, wherein the video field generator component is further arranged to determine whether the field Rₖ comprises a field 1 or a field 2, and to generate the video field Rₖ further based on the determination of whether the field Rₖ comprises a field 1 or a field 2.

15. The video processing apparatus of claim 14, wherein the video field generator component is arranged to:
generate the video field Rₖ from the determined source video frame using a field 1 sample grid if the field Rₖ comprises a field 1; and
generate the video field Rₖ from the determined source video frame using a field 2 sample grid if the field Rₖ comprises a field 2.

16. The video processing apparatus of claim 10, wherein the video field generator component is further arranged to output the generated video field Rₖ.

17. The video processing apparatus of claim 16, wherein the video field generator component is arranged to output the generated video field Rₖ as part of a video stream comprising the video field sequence R of N_{R} video fields.

18. The video processing apparatus of claim 16, wherein the video field generator component is arranged to output the generated video field Rₖ to at least one of:
a video transmission apparatus;
a display apparatus; and
a data storage device.

19. A video processing apparatus of claim 10, wherein the at least one video field generator component uses a non-transitory computer program product having stored therein executable program code for performing a method of generating a video field Rₖ within a video field sequence R of N_{R} video fields.
